(19) United States
(12) Patent Application Publication
(10) Pub. No.: US 2004/0049978 A1
(43) Pub. Date: Mar. 18, 2004

(54) Combined controller apparatus for a horticultural watering system

(76) Inventors: Edwin A. Lips II, St. Louis, MO (US); Jon S. Lips, Parker, CO (US)

Correspondence Address: MARSH FISCHMANN & BREYFOGLE LLP, Suite 411, 3151 S. Vaughn Way, Aurora, CO, 80014, US

(21) Appl. No.: 10/648,932

(22) Filed: Aug. 27, 2003

Related U.S. Application Data
(60) Provisional application No. 60/411,028, filed on Sep. 16, 2002.

(51) Int. Cl. A01G 29/00

(52) U.S. Cl. 47/48.5

(57) ABSTRACT

A system and method that provides for injection control of a liquid additive in a liquid dispensation system. Included as part of the system is a controller device configured to generate one set of control signals for initiating and terminating liquid dispensation to one or more areas while simultaneously generating at least one second control signal which controls the injection rate of a liquid additive to the liquid being dispense. The liquid dispensation rate may be controlled according to a number of criteria, which are received from an external source from the controller or retrieved from an internal memory. The system may be further configured such that the dispensation rate is modified according to a detected condition.

### RELATED APPLICATIONS

This application claims priority under 35 U.S.C. Section 119 to prior U.S. Provisional Patent Application Serial No. 60/411,028 filed on Sep. 16, 2002. The entirety in which is hereby incorporated by reference.

### FIELD OF THE INVENTION

The present invention relates to horticultural liquid dispensation system, and more particularly to a dispensation system and method which employs a combined controller apparatus.

### BACKGROUND OF THE INVENTION

Various approaches have been proposed for the injection of liquid additives into horticultural water and systems. A particular interest, liquid fertilizers have been injected into water and systems employed in the turf growth/maintenance industry for many years.

Known approaches for liquid fertilizer injection have included both powered and non-power systems. By way of primary example, metering pumps have been utilized in connection with golf course watering systems around the world. Such systems have proven to expensive to implement in many applications, including for example residential sprinkler systems.

It has been recognized that the application of small dosages of fertilizer to turf or foliage over an extended time is preferable to a single high dosage application. Low dosages avoid extreme growth/burning cycles, and otherwise enhance the establishment of desirable root structures. In turn, weed infestation is significantly reduced.

In a typical horticultural dispensation system, the system for controlling the zone is separate from the system which controls fluid injection into the water supply. As such, various connections between the zone controller and the dispensation controller are necessary so that amounts of liquid additives can be changed according to the particular zone which is currently being watered.

### SUMMARY OF THE INVENTION

Described herein is a system and method for controlling the injection of a liquid additive in a liquid dispensation system. In one configuration of the invention, a controller device is configured to generate one set of control signals for initiating and terminating liquid dispensation to one or more areas (zones) while simultaneously generating a least one second control signal which controls the injection rate of a liquid additive to the liquid being dispensed. The second control signal which is transmittable to one or more injector apparatus may be generated based on one or more criteria, which includes but is not limited to information about a particular zone, instructions manually entered through a user interface such as a keypad or card reader device, as well as inputs received from one or more external devices, such as sensors. The system may be further configured that upon detection of any number of conditions, such as expiration of a time period, the second control signal may be modified or terminated to account for the new condition.

In one configuration of the invention, the system described herein may include a microcontroller with a plurality of signal outputs. One portion of the signal outputs may be directed to one or more zone control devices, such as solenoid valves, which when opened provides for the application of a liquid to a particular zone. Other outputs may be configured to carry control signals to one or more injector assemblies. Included as part of these injector assemblies may be at least one injector, which is employed to inject an amount of the additive in the liquid to be dispensed in the zone.

Also in connection with the microcontroller may be one or more interface devices. These interface devices may include manual input devices such as buttons and/or keypads through which a system user may manually enter information such as instructions to be employed by the microcontroller in dispensing the liquid. Other interfaces may be employed for receiving signals from external devices, such as sensors, which are also processed by the microcontroller in controlling the injector rate for the additive.

Further in connection with the microcontroller may be one or more memory devices, such as a database, which is employable to store information relating to amounts of additive to be injected to one or more zones. Other information which is storable in memory may relate to injection rates which are based upon external information received, such as a system user inputting information as to the geographic region in which the controller is operating.

In one configuration of the invention, the injector control signals may be configured to control the operation of injector devices such as variable speed DC or AC motor driven pumps, flow through or water driven hydraulic pumps via an electric needle valve. The system may be configured to variably control the rate of dispensation based on flow data watering changes, system zone information and/or other including hydraulic solenoid operated piston pump. The injection devices may further include electric metering pumps, variable speed electric pumps, pulse activated hydraulic pumps and any other electrically controlled valve or pump designed to inject liquid.

In one configuration of the invention, the output signal may be a pulsing signal. The signal may be user or sensor controlled such that the oscillation (e.g. the flow on and flow off percentage) provides for a specified injection rate.

The system may be further configured to generate that multiple control signals which are transmittable to a plurality of injector devices which inject a plurality of chemicals for dispensation in a particular zone. For example, this system may be programmed such that due to conditions of a zone, it is desired that individual additive such as nitrogen, potassium, and/or phosphorus are separately controlled. Through the use of a single controller, multiple control signals are transmitted to the individual injectors which in turn are connected to supplies of the particular chemicals. Each injector will then provide for the injecting of the additive to the liquid supply, which then may be dispensed in a particular zone. For a complex system like a greenhouse with many different varieties of horticultural materials, the operator could specify various nutrient levels for each of the different plants via the sprinkler system with one set of injectors and one set of nutrient tanks.

The central controller may be further configured as a modification of a current controller for a liquid dispensing system, wherein it is reconfigured through implementation of software or hardware modifications to output one or more injector control signals. In another configuration of the invention, a separate controller may be installed in a common housing with a current controller, and a data link established between the controllers to provide for the generation of control signals transmittable to the injector assemblies.

In yet another configuration of the invention, the system described are may be configured to communicate with one or more sensors which provide input signals which are employable in controlling the injection rate for a particular chemical. For example, connections could be established with one or more weather station which would provide up to date rainfall, humidity, evapotranspiration rates, etc. for the environment in which the liquid is to be employed. Further, sensors such as conductivity or PH may be employed to control the amount of one or more chemical additives to a particular zone.

In operation, either automatically or manually, operation may be initiated wherein liquid is to be dispensed in a sequence of zones. Upon initiation of operation, a first zone is identified and the controller may access the memory to retrieve information relating to the particular zone. Further, in a dynamic system, information received from one or more external sources, such as sensors, may be employed either alone or in combination with the data retrieved from memory in order to calculate an injection rate for one or more additives to the selected zone. Once the desired injection rate is identified, one or more control signals may be generated and output to the one or more injectors which provide for the injection of the additive.

In a dynamic system the sensor inputs may be further employed with the retrieved data, or alone, to generate the injector control signals. After a manual termination signal is received, or after a specified time period has expired, the central controller may then terminate the transmission of the control signal. At this point a next zone may be identified and the process begun again. This may continues until all zones are covered or the process is otherwise terminated.

### BRIEF DESCRIPTION OF THE DRAWINGS

FIG. 1 illustrates one embodiment of the present invention as implemented with an exemplary conventional lawn sprinkling system.

FIG. 2 discloses a system diagram of the combined controller.

FIG. 3 discloses a flow chart, which describes the operational step of the dual controller.

### PREFERRED EMBODIMENT

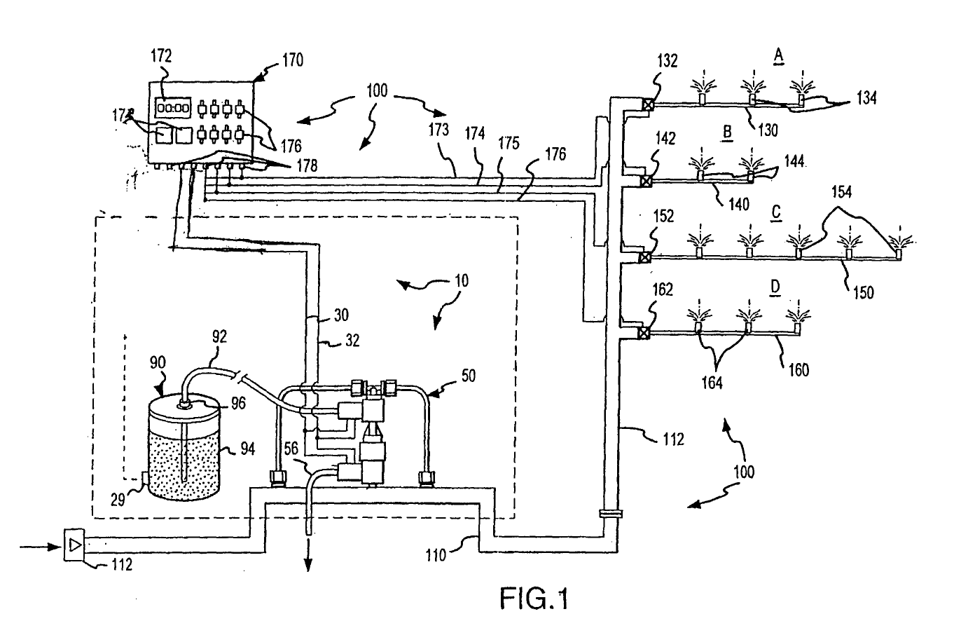

FIG. 1 illustrates one embodiment 10 of the present invention as implemented with an exemplary conventional lawn sprinkler system 100, which is also described in U.S. Pat. No. 6,314,979 which is hereby incorporated in its entirety by reference. As will become apparent, the described embodiment 10 may be packaged and installed with a conventional system 100 or may be readily implemented to interface with a previously instilled conventional system 100. Further, the described embodiment 10 comprises features that may be readily adapted for use in connection with liquid dispensation systems other than the illustrated exemplary system 100. For example, the present invention may be utilized in connection with hydroponic growth systems and tank-fed, sprayer systems.

In the exemplary watering system 100, a main watering system line 110 is fluidly interconnected to a main water supply (e.g. a city water supply or pump supply line) via valve 112, wherein water within the main water line 110 is “pressurized”. Pressurization within the main water line 110 may also be provided via one or more dedicated pumps for the watering system. The main water line 110 is fluidly interconnected by a manifold 112 to a series of watering zone feed lines 130, 140, 150 and 160, via corresponding solenoid valves 132, 142, 152 and 162, respectively. Each of the zone feed lines 130, 140, 150 and 160 supply one or more corresponding water emitters (e.g. spray heads, drip heads, etc.) 134, 144, 154 and 164, respectively. The selective actuation, or opening/closing, of solenoid valves 132, 142, 152 and 162 may be effected via the transmission of electrical control signals by a main controller 170 through corresponding control signal lines 173, 174, 175 and 176, so as to effect the desired watering of corresponding watering zones A, B, C and D, respectively.

In the exemplary watering system 100, controller 170 includes a control clock 172, programming input keys 173, and duration-setting controls 176. The programming input keys 173 and duration-setting controls 176 may be utilized to establish one or more desired start time(s) for the watering system and the desired length of each watering period for each of the watering zones A-D serviced by corresponding solenoid valves 132, 142, 152 and 162, respectively. While the programmable controller 170 shown in FIG. 1 includes eight durational control knobs 176, and corresponding control signal line output ports 178 (e.g. to service up to eight corresponding watering zones), controller 170 may be provided with more/less zone control knobs/output ports. Similarly, while FIG. 1 shows an exemplary watering system 100 servicing four watering zones A-D, more/less zones may be readily defined in corresponding relation to the number of zone watering controls provided by a given controller 170.

Most typically, the control clock 172 of controller 170 will be set in accordance with real clock time and program input keys 174 will be utilized to establish one or more set times to initiate automatic operation of the system. Upon initiation of a watering cycle, controller 170 may be programmed to automatically transmit control signals through control lines 173, 174, 175 and 176 in a successive manner, wherein valve 132 stays open for a durational period set by the corresponding control 176 for zone A, then valve 132 closes and valve 142 is opened for a durational period set via the corresponding control 176 for zone B, and so on. Numerous additional features and configurations of exemplary watering system 100 will be known to those skilled in the art and are employable with the present invention, including the described embodiment 10.

In the later regard, the invention embodiment 10 shown in FIG. 1 includes an injection assembly 50 and a liquid additive containment assembly 90. Injection assembly 50 is fluidly interconnected to the main watering system line 110 as well as the liquid additive containment assembly 90. Further, injection assembly 50, is electrically interconnected to programmable controller 170 via injection signal circuit lines 30 and 32. As will be further described, injection assembly 50 operates to successively draw a predetermined amount, or “slug”, of liquid additive from containment assembly 90 and inject such “slugs” into the main water line 110 of exemplary watering system 100 in response to electrical pulses received via injection signal circuit lines 30 and 32 from programmable controller 170. The injection pulses are transmitted by programmable controller 170 at a predetermined rate that is selectable by a user on a watering zone-specific basis.

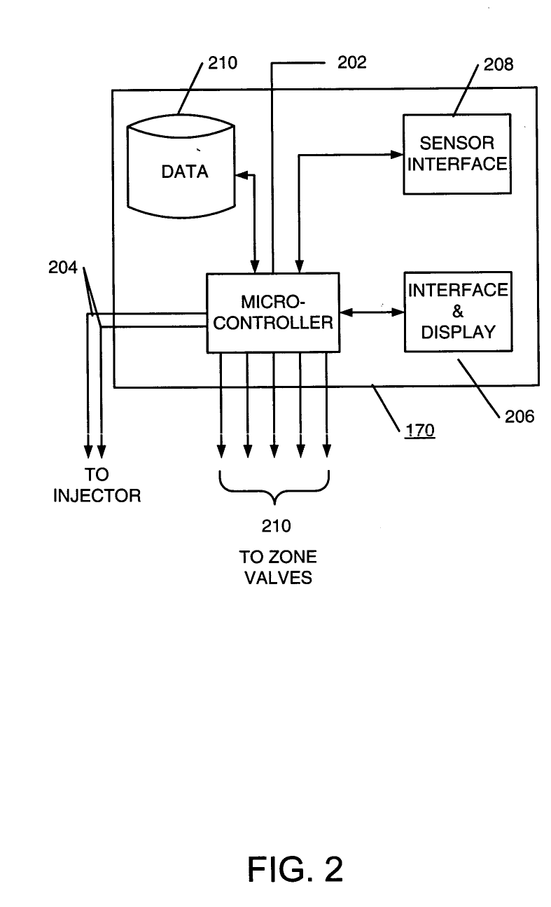

Disclosed in FIG. 2 is a system diagram for the programmable controller 170. Incorporated in the programmable controller is a microcontroller 202, which may be configured as any number of microprocessor devices currently available, which are configured to control one or more aspects of computerized systems. Exiting from the microcontroller are output lines 210 which are in electrical connection with the solenoid valves for controlling water flow to the watering zones. Signals carried over the output lines provide for the activation and de-activation of the solenoid valves. Also output from the microcontroller 202 are output lines 204 which are in electrical connection with the injector assembly. These signals control the rate of injection of the liquid additive in the water supply.

The control signals may be configured as either analog or digital signals to control the rate of injection via such things as motor speed, pulse rate, flow valve pulsing, etc. For example, when a pulse signal is sent, the pulsing would create a user controlled or sensor controlled flow on and flow off percentage thereby creating a specified injection rate. The system could further provide an analog output to control the motor speed via DC voltage or AC frequency. The control signals may also be configured to control motor speed as of a stepper motor driven variable controlled valve or alike. This allows precise injection to be programmed by the user or controlled via a sensor input. More specifically, injection systems which may be controlled, include hydraulic, solenoid operate piston pump, variable speed DC or AC motor driven pumps, or even flow through water driven hydraulic pumps via an electric needle valve, which variably control the rate of dispensation based on flow data or system zone sensing, through use of analog or digital data received.

Further in connection with microcontroller 202 is the interface and display device 206 which provides for the manual programming of the microcontroller as well as the display of the operational status of the system. The interfaces may include any number of switches, buttons, keypads, and/or any other input devices configurable in the housing of the controller unit. The displays may comprise any numbers of display devices such as LED's and/or LCD's for the display of operational information relating to the operation of the system.

Further in connection with microcontroller 202 is interface 208 which is configured to be connectable to any number of external devices such as sensors which sense conditions which may affect the amount of additive injected in the water supply. The sensors may include weather stations or soil condition sensors such as those which sense conductivity and Ph. Still further in connection with microcontroller 202 may be one or more memory devices 210 which are configured to store operational information relating to the operation of the system. This information may include, but is not limited to, injection rates for a particular zone, geographic information which may affect injection rate, data relating to soil types which may affect injection rates. In one use of the memory device this information which is stored in memory may be presented on the display 206, and through the use of various interface devices, a user may select this data and it may be employed in controlling the injection of additives in one or more of the zones. This information may also be retrieved by the controller during operations and automatically used to control injection rates.

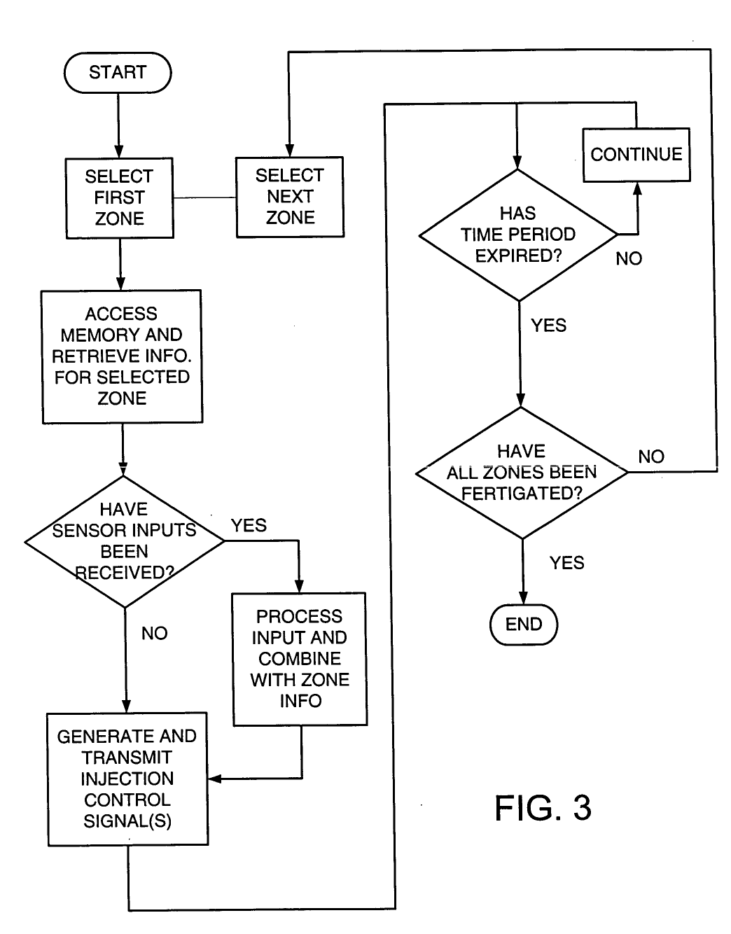

Disclosed in FIG. 3 is a flow chart which describes in detail the various operational steps performed by the controller for the control of an additive to one or more watering zones. Before the controller even begins watering operations, a system user may provide various programming for watering the particular zones. For example; based on what is being watered in a particular zone, the system user may enter a desired additive injection rates. Other information which may be entered may be certain geographical climatologically, and/or horticultural information about the environmental conditions that the horticultural material being watered experiences. Through use of data stored in memory the microcontroller may be configured such that based on this entered information, a desired additive injection rate may be calculated. For example, a country like the United states may be divided into a 10 geographic regions. These regions might have similar average annual rainfall and/or similar evapotranspiration rates and/or similar soil types. The controller will then ask for data relating to the horticultural material grass, woody ornamentals, trees and/or xeriscape. This information may be entered for each watering zone. The user will then enter the size and GPM flow of each system zone. From this data, the system may be configured to calculate ideal watering times and duration as well as fertilization rates based on industry accepted standards.

Further, in order to determine injection rates, various sensor inputs may be received which may be used to calculate or recalculate ideal rates based on entered information. Fertility would be the most likely thing controlled but also antitransprints or even some fungicides might be applicable. Other sensor inputs which may affect the concentration in the system may include conductivity or PH, for example, that directly relate to the additive concentration. For example, the system may be configured to control parts per million of nitrogen, part per million of phosphorus, and parts per million of potassium, wherein the injector assembly includes multiple injectors and each injector controls the addition of a particular nutrient. In the system, multiple tanks including additives may be employed wherein a particular injector is associated with a particular tank.

Returning again to the flow chart of FIG. 3, during operation of the watering system, the microcontroller will select a first zone to begin watering. At this point, the microcontroller will access the memory and retrieve information stored therein relating to the watering of the particular zone. Alternatively, or in combination, instructions relating to the injection of additives may be received manually through the user interface. A further query may be made as to whether a received external input, such as from a sensor, shall be processed in order to calculate a injection rate for the particular zone. This external information may be employed alone or in combination with stored data.

Once the data has been retrieved from memory and any external inputs processed, one or more control signal(s) for controlling the injection rate(s) may be generated and transmitted to the relevant injector. As was noted above, a particular controller may be configured to control one or more injectors and as such, injection control signals are transmitted to each of the appropriate injector assemblies. Once the signal is transmitted, the controller may monitor the operation and at the end of a designated time period, terminate the transmission of the particular control signal. The controller may also be configured to change the control signal during the watering process based on one or more inputs received.

Once the time period has expired and the control signal is terminated, the microcontroller identifies the next zone to be watered and the memory is access to retrieved information relating to that zone. The above process is then repeated. In a situation where all zones have been water, the watering process is terminated.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, within the scope of the present invention. The embodiments described hereinabove are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A liquid delivery system for horticultural application, comprising:
a controller device electrically connectable to a zone watering control system where the controller is configured to generate and transmit configured fluid control signals to selectively control the flow of pressurized fluid to a plurality of fluid delivery zone; and
said controller further configured to be electrically connectable to at least one additive injector for introducing said liquid additive into said pressurized fluid flow, said controller being further configured to generate one or more injection control signals to selectively control an injection rate of a liquid additive into said pressurized fluid flow, wherein said injection control signals are generated in accordance with at least a first criteria associated with said fluid control signals.

2. The system of claim 1, wherein said at least a first criteria associated with said fluid control signals include at least one of: stored data from a memory structure, instructions entered through a user interface and external data received from at least a first external device.

3. The system of claim 2, wherein said stored data includes at least one of:
zone information for each said fluid delivery zone in said liquid delivery system;
geographic information relating to at least a first environmental condition associated with the region in which said liquid delivery system is located;
horticultural information relating to plant types associated with each said fluid delivery zone in said liquid delivery system.

4. The system of claim 3, wherein said zone information includes a flow rate for said each said fluid delivery zone.

5. The system of claim 3, wherein said geographic information includes information relating to a least one of: soil types associated with said region, precipitation information associated with said region.

6. The system of claim 2, wherein said external data received from at least a first external device includes at least one of:
weather related information received from a weather sensor in data communications with said controller; and
soil related information received from a soil sensor in data communications with said controller.

7. The system of claim 1, wherein said injector control signals may be dynamically modified in response to a change detected in said at least a first criteria.

8. The system of claim 1, wherein said injector control signals comprise electrical controls for selectively control the rate said additive injector introduces said liquid additive into said pressurized fluid flow.

9. The system of claim 8, wherein said electrical control signals comprise at least one of: pulsating electrical signals, analog signals; and digital signals.

10. The system of claim 1, wherein said additive injector comprises at least one of: a motor driven pump, and a hydraulic pump.

11. The system of claim 1, wherein said controller is configured to generate a plurality of said control signals to selectively control an injection rate of a plurality of liquid additives into said pressurized fluid flow.

12. The system of claim 1, wherein said controller further comprises;
a first controller for generating said fluid control signals; and
a second controller adapted to operate in conjunction with said first controller to generate said injection control signals, wherein said second controller is in data communication with said first controller.

13. A controller for a horticultural watering system, said controller comprising:
a microcontroller device configured for generating a plurality of output signals, wherein the plurality of output signals include a first output signal a first portion selectively directed to a plurality of zone control devices for controlling the flow of pressurized fluid to individual zones of said watering system and a second output signal selectively directed to an injector apparatus for controlling the injection rate of an additive to said pressurized fluid;
an interface device in communication with said microcontroller device, said interface device configured to receive information relating to fluid dispensation from one or more external sources;
a memory device in communication with said microcontroller device for storing the information relating fluid dispensation employable in generating the plurality of output signals; and
wherein said microcontroller device utilizes the information relating to fluid dispensation to generate said plurality of output signals.

14. The controller of claim 13, wherein said interface device comprises a user interface for allowing a user to manually enter information for use in generating said plurality of signal outputs.

15. The controller of claim 14, wherein said use interface is farther configured to include at least one display for displaying information relating to an operational status of said watering system.

16. The controller of claim 15, wherein said at least one display is configured to display a plurality of user selectable options associated with said watering system, wherein said user selectable options are utilized by the microcontroller apparatus to generate said plurality of output signals.

17. The controller of claim 13, wherein said interface device comprises a data input port for electrically connecting to the one or more external sources.

18. The controller of claim 13 wherein the data interface includes at least one of: a keypad device and a card reader.

19. The controller of claim 17, wherein said data port is configured to receive data signals from at least one of a weather station operable to provide information regarding current weather conditions and a soil sensor operable to provide information regarding current soil conditions.

20. The controller of claim 13, wherein said memory structure comprises at least a first database for storing second information related to at least one:
said additive;
geographic information relating to the a geographic region in which said watering system is located; and
horticultural information relating to plant varieties said watering system waters.

21. A method for controlling injection of a liquid additive into a horticultural liquid dispensation system, comprising the steps of:
sequentially identifying a zone in said watering system;
accessing a memory structure to retrieve zone information related to said zone;
processing said zone information retrieved for said zone to, first generating a fluid flow control signal to control the flow of pressurized fluid to said zone; and
second generating an injector control signal to control the injection rate of an additive into said flow of pressurized fluid; and
transmitting said fluid flow control signal and said injector control signal to a flow control device and a injector device, respectively.

22. The method of claim 21, wherein said first ad second generating steps are performed concurrently.

23. The method of claim 21, further comprising:
receiving at least one data input from a data interface, wherein said data input is processed in combination with said zone information to generate said injection control signal.

24. The method of claim 23, wherein said at least one data input is received from a user interface, wherein a user enters said at least one data input.

25. The method of claim 23, wherein said at least one data input is received from a sensor external to said watering system.

26. The method of claim 24, wherein said data input is received from at least one of;
a weather station; and
a soil sensor.
